(19) United States
(12) Patent Application Publication
(10) Pub. No.: US 2025/0130836 A1
(43) Pub. Date: Apr. 24, 2025

(54) MECHANISM FOR FINE-GRAINED DEVICE POWER ATTRIBUTION TO SOFTWARE ENTITIES

(71) Applicant: Ampere Computing LLC, Santa Clara, CA (US)

(72) Inventors: Yogesh BANSAL, Beaverton, OR (US); Sanjay Bhikhubhai PATEL, Cary, NC (US); Hoan TRAN, San Jose, CA (US); Shivnandan KAUSHIK, Portland, OR (US); Vanshidhar Reddy KONDA, Portland, OR (US)

(21) Appl. No.: 18/490,622

(22) Filed: Oct. 19, 2023

(51) Int. Cl. G06F 9/455

(52) U.S. Cl. CPC G06F 9/45558

(57) ABSTRACT

An integrated circuit (IC) device with capability to finely determine power attributions to software entities is disclosed. During each digital power meter (DPM) interval, and for each virtual machine (VM) (e.g., an instantiation of a software entity), power consumed by the cores, memory, and/or IO ports of the compute node in executing that VM may be determined. The power attribution information may be provided to higher level profilers so that over-subscription of power can be avoided. The power attribution information may be gathered without using cycles of the cores of the compute node.

### FIELD OF DISCLOSURE

This disclosure relates generally to devices such as integrated circuit devices including system-on-chips (SoC). More specifically, but not exclusively, to a mechanism for fine-grained device power attribution to software (SW) entities being executed on the device, and fabrication techniques thereof.

### BACKGROUND

Hyper-scalar cloud service providers (CSP) increase the computational density of their data centers by populating compute nodes per rack and racks per cluster in the datacenter that over-subscribes the total power available for the data center. Such an oversubscription model depends on the fact that compute nodes do not run at their full specified power for most of the time.

However, to safely oversubscribe power without causing breaker triggers and associated black-out risks, CSPs need to implement solutions for placement of SW entities to compute nodes to reduce the probability of compute node level power thresholds being exceeded. In the event of compute node-level power being exceeded, the CSPs also need to implement throttling performance on the compute node to reduce the power consumption level. Such throttling can hinder performance.

It may be possible to implement an infrastructure in the system software to collect “raw” SoC ingredient level power at the cost of a significant overhead in critical context switching flows to accurately allocate the SOC energy to SW entities. Such a mechanism would have a significant overhead in the operating system limiting usage in a production environment.

Accordingly, there is a need for systems, apparatus, and methods that overcome the deficiencies of conventional devices including the methods, system and apparatus provided herein.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

An exemplary compute node is disclosed. The compute node may comprise a plurality of hardware (HW) entities associated with executions of one or more virtual machines (VM). Each VM may be an instantiation of a software (SW) entity of one or more SW entities. One or more first HW entities of the plurality of HW entities may be associated with an execution of a first VM of the one or more VMs during a digital power meter (DPM) interval. The first VM may be an instantiation of a first SW entity for execution on the IC device. The device may also comprise a microcontroller (Mpro) configured to determine, for the first VM, a first VM power representing power consumed by the one or more first HW entities while executing the first VM during the DPM interval.

A method of attributing power to a compute node is disclosed. The compute node may comprise a plurality of hardware (HW) entities and a microcontroller (Mpro). The plurality of HW entities may be associated with executions of one or more virtual machines (VM). Each VM may be an instantiation of a software (SW) entity of one or more SW entities. One or more first HW entities of the plurality of HW entities may be associated with an execution of a first VM of the one or more VMs during a digital power meter (DPM) interval. The first VM may be an instantiation of a first SW entity for execution on the IC device. The method may comprise determining by the Mpro, for the first VM, a first VM power representing power consumed by the one or more first HW entities while executing the first VM during the DPM interval.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example of a compute node in accordance with one or more aspects of the disclosure.

FIG. 2 illustrates an example flow of fine-grained power estimation in a compute node in accordance with one or more aspects of the disclosure.

FIGS. 3-9C illustrate flow charts of example methods of fine-grained power estimation in a compute node in accordance with one or more aspects of the disclosure.

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

As indicated above, organizations such as cloud service providers (CSP) increase the computational density of their data centers by over-subscribing the total power available for the data center. Thus, it becomes necessary for CSPs to implement solutions for placement of SW entities to compute nodes or devices to reduce the probability of compute node level power thresholds being exceeded. This oversubscription model depends on the fact that compute nodes do not run at their full specified power for most of the time.

However, to safely oversubscribe power without causing breaker triggers and associated black-out risks, CSPs place SW entities to compute nodes o reduce the probability of compute node level power thresholds being exceeded. SW entities can be either virtual machines (VMs) or containers based on the CSP operating system model. When the compute node-level power is exceeded, the compute node performance can be throttled intelligently where lower priority SW entities are throttled first to manage the compute node-level overage prior to high priority SW entities being throttled.

To address such issues and other disadvantages of conventional power usage information gathering, a mechanism is proposed to provide a low overhead fine-grained power telemetry and capping capability in a compute node (e.g., in an SoC). The mechanism may give system software a “per SW entity” granularity level accumulation of the SoC energy to enable intelligent placement of workloads. The mechanism may also provide ability to specify priority of SW entities running on a compute node that the SoC can use to determine sub-SOC components (cores, memory control units (MCU), . . . ) to cap power in a prioritized fashion. The mechanism may further provide an ability to establish and cap SoC power usage on a per SW entity basis that reflects priority of the SW entity.

The proposed mechanism may be built on a digital power meter (DPM) power estimation model (PEM) that estimates per core energy, MCU energy, IO root complex (RC) energy, among others at a fine grain (e.g., DPM interval). The power estimation may be made using (among others):
Weighted sum of key power-event monitors for dynamic power (in hardware, DPM loop);
Dynamic-power at no activities, leakage power at base-temperature (characterization and silicon measurement);
Voltage, temperature from sensors (silicon measurement); and
Dynamic and leakage power scaling with voltage and temperature (characterization).

An embedded microcontroller (Mpro) may collect fine-grained (e.g., per core, MCU, IO RC, mesh, etc.) information, sensor data at periodicity of a DPM interval loop (e.g., 500 μs or less, or even 200 μs or less). The Mpro may also calculate power per core, MCU, IO RC, mesh, etc. with the collected information. In general, the Mpro may calculate power per hardware (HW) entity during each DPM interval.

One significant aspect is that a SW entity may be associated with a unique identifier so that power consumed by the SW entity may be sampled and attributed to the associated unique identifier at every DPM interval trigger point. As an illustration, a SW entity identifier for an advanced RISC (reduced instruction set computer) machine (ARM) can include VMID (virtual machine ID), ASID (address space ID) or PARTID (partition ID), which individually or collectively can be used by system software and the SoC to uniquely identify the SW entity.

In an aspect, the DPM interval is significantly smaller than typical “minimum residence quantum” for commercial operating systems which provides a probabilistically accurate profile for the SW entities residency on the core. It is proposed to accumulate the per hardware (HW) entity (e.g., core, MCU, IO, etc.) by SW entity accounting for all the HW entities the SW entity runs on during the DPM interval.

In some instances, approximations may be made. For example, there can be instances where a SW entity can be switched out during a DPM interval. That is, a HW entity (e.g., core) may be executing a first SW entity at the beginning of the DPM interval, which may be switched out during the DPM interval. That is, the same HW entity may be executing a second SW entity before the DPM interval ends. In an aspect, such scenarios may be detected by SW entity identity comparison at start and end of the DPM interval with energy during that interval for that HW entity, and the energy used by the HW entity during the DPM interval may be divided (e.g., equally) between the first and second SW entities.

For some HW entities such as cores, it may be possible to directly attribute the energy/power used by that HW entity to the SW entities. But for some other HW entities (e.g., MCU, IO RC, mesh, etc.), it may be difficult to make such direct attribution of power to the SW entity. In these instances, the power used by these other HW entities may be divided among the active HW entities (e.g., all active cores) in which such direction attribution may be made. For example, the total HW entity power used by the other HW entities may be calculated and divided (e.g., equally, proportionately, etc.) among the SW entities that runs on the active HW entities during the DPM interval. The remainder of the compute node energy, which is normally a small fraction of total energy, may also be divided (e.g., equally, proportionately, etc.) among all active HW entities.

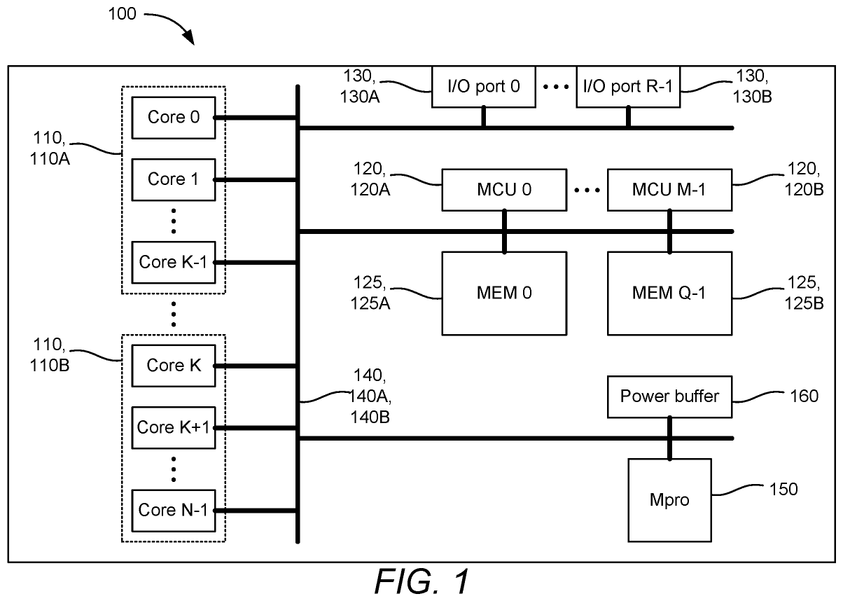

FIG. 1 illustrates an example of a compute node in accordance with one or more aspects of the disclosure. The compute node 100 may comprise a plurality of cores 110, one or more memory controllers (MCU) 120 controlling access to one or more memories 125 (MEM), one or more I/O ports 130, and one or more meshes 140 interconnecting the components of the compute node 100. In FIG. 1, N represents the number of cores 110 (N≥2), M represents the number of MCUs 120 (M≥1), Q represents the number of memories 125 (Q≥1), and R represents the number of I/O ports (Q≥1).

The plurality of cores 110 may execute one or more virtual machines (VM). Each VM may be an instantiation of a SW entity, such as an application, process, thread, etc. In FIG. 1, one or more first cores 110A (e.g., cores 0 to K−1) may execute a first VM, and one or more second cores 110B (e.g., cores K to N−1) may execute a second VM. Of course, the plurality of cores 110 may execute more than two VMs during a DPM interval. Indeed, it is also contemplated that any particular core 110 may execute more than one VM during the DPM interval.

The one or more MCUs 120 may control access (e.g., read, write) to the one or more memories 125 to enable execution of the one or more VMs during the DPM interval. Regarding the memories 125, it is intended that many types of data storage devices (e.g., DRAM, SRAM, cache, buffers, etc.) are encompassed as memories 125. In FIG. 1, one or more MCUs 120A may be instructed to or otherwise control access to the memories 130 in association with the first VM. Also, one or more MCUs 120B may be instructed to or otherwise control access to the memories 130 in association with the second VM. Of course, the MCUs 120 may control access to the one or more memories 125 to enable execution of more than two VMs during a DPM interval. It is also contemplated that any MCU 120 may control access to the memories 125 to enable execution of more than one VM during the DPM interval.

The one or more I/O ports 130 may interface to send/receive information to enable execution of the one or more VMs during the DPM interval. In FIG. 1, one or more I/O ports 130A may be send and/or receive information in association with the first VM. Also, one or more I/O ports 130B may be send and/or receive information in association with the second VM. Of course, the I/O ports 130 may control send/receive information to enable execution of more than two VMs during a DPM interval. It is also contemplated that any I/O port 130 may send/receive information to enable execution of more than one VM during the DPM interval.

The compute node 100 may also include a microcontroller (Mpro) 150 and a power buffer 160. The Mpro 150 may be configured to determine VM powers-power used in execution of the VMs such as first and second VMs during each iteration of the DPM intervals. That is, during a DPM interval, the Mpro may determine a first VM power and a second VM power, among others. The Mpro 150 may be configured to determine—for each VM that is executed over multiple DPM intervals—the corresponding VM powers over the multiple DPM intervals. For example, if the first VM is executed over multiple DPM intervals, the Mpro 150 may determine the corresponding multiple first VM powers. Similarly, if the second VM is executed over (same or different) multiple DPM intervals, the Mpro 150 may determine the corresponding multiple second VM powers.

The Mpro 150 may store the VM powers (including the first and second VM powers) in the power buffer 160. In an aspect, the power buffer 160 may be invisible to the plurality of cores 110 and to the one or more MCUs 120. That is, the power buffer 160 may be separate from memories and/or buffer (such as memories 125) used to hold data in execution of the one or more VMs.

Indeed, some or all of the HW entities—the cores 110, the MCUs 120, the memories 125, the I/O ports 130, and the I/O ports 140—need NOT be involved in determining the VM powers. For example, the cycles of the plurality of cores 110 need not be used in determining any of the VM powers including the first and/or the second VM powers. This means that little to no overhead from the HW entities is required for the fine-grained power estimation.

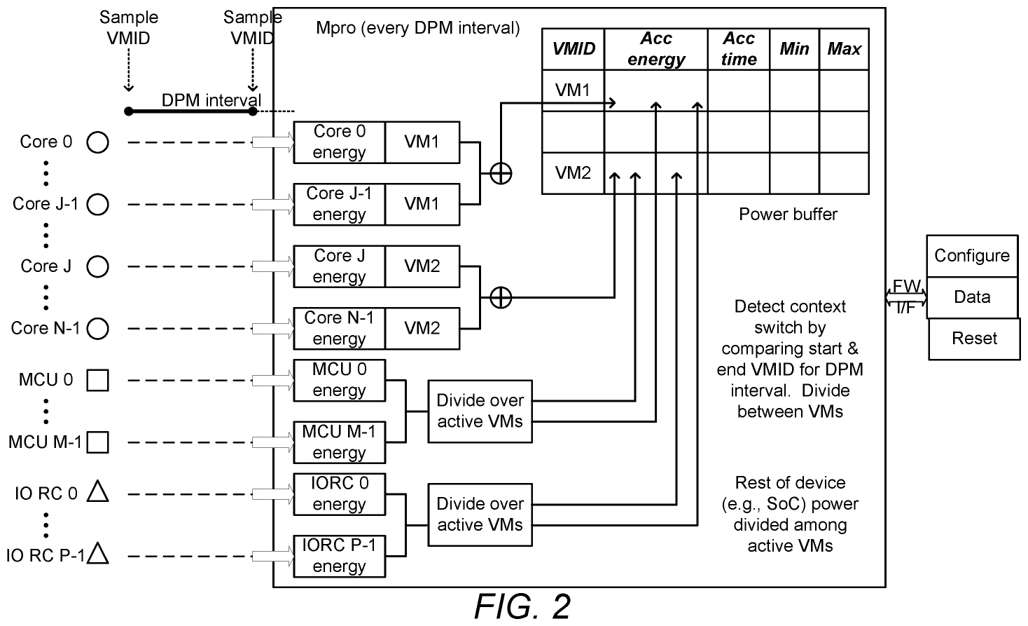

FIG. 2 illustrates an example flow of fine-grained power estimation in a compute node, such as the compute node 100, in accordance with one or more aspects of the disclosure. In an aspect, each SW entity may be uniquely identified through a SW entity ID. In this instance, VMID is used. However, it should be noted that SW entity may also be identified through other identifiers, including but not limited to address space ID (ASID) and partition ID (PARTID). In FIG. 2, the first VM is assumed to be identified as VM1, and the second VM is assumed to be identified as VM2.

The Mpro 150 may be configured to determine total accumulated energy—also referred to as VM power—for each of the VMs during each DPM interval. That is, regarding the first and second VMs, the Mpro 150 may determine the first VM power (total accumulated energy consumed by first HW entities (e.g., 110A, 120A, 130A, 140A) to execute the first VM) and may determine the second VM power (total accumulated energy consumed by second HW entities (e.g., 110B, 120B, 130B, 140B) to execute the second VM) during the DPM interval. In an aspect, at least one first HW entity may be different from at least one second HW entity. For example, one core 110 may be executing the first VM and another different core 110 may be executing the second VM during the DPM interval.

In an aspect, the VM power for each of the one or more VMs may include core powers (power consumed by the cores 110), memory powers (power consumed in accessing memories 125 through MCUs 120), I/O powers (power consumed by the I/O ports 130), and mesh powers (power consumed by the meshes 140). That is, the first VM power may include first core power(s), first memory power(s), first I/O power(s), and first mesh power(s). Also, the second VM power may include second core power(s), second memory power(s), second I/O power(s), and second mesh power(s).

In an aspect, during each DPM interval, the Mpro 150 may determine a core power of each core and identify the VMID of the VM executed on that core 110. Here, core power maybe viewed as the power consumed by the core 110. Then for each VMID, the Mpro 150 may accumulate or sum the powers consumed by the cores 110 that executed the VM corresponding to that VMID. The VM power of a VM may include the accumulated core powers. Then the Mpro 150 may include the accumulated core powers for each VM (identified with corresponding VMID) in the power buffer 160.

In FIG. 2, it is assumed that J cores (cores 0 to J−1) executed the first VM and that N-J cores (cores J to N−1) executed the second VM during the DPM interval. The Mpro 150 may determine J first core powers and N-J second core powers. The first VM power (stored in “Acc energy” part of power buffer 160) associated with the first VMID (VM1 in FIG. 2) may include the accumulated J first core powers. Similarly, the second VM power associated with the second VMID (VM2 in FIG. 2) may include the accumulated N-J second core powers.

While not shown, similar techniques may be employed for other HW entities such as the MCUs 120 and memories 125, the I/O ports 130, and/or the meshes 140. For example, regarding the MCUs 120 and memories 125, the Mpro 150 may be able to determine a memory power of each MCU 120 and identify the VMID corresponding to the memory power. Here, memory power maybe viewed as the power used to access memory associated with each VM (e.g., as instructed by the MCU 120). Then for each VMID, the Mpro 150 may accumulate or sum the memory powers corresponding to each VM, and the accumulated memory powers may be included in the power buffer 160 corresponding to the VMIDs.

As another example, regarding the I/O ports 130, the Mpro 150 may be able to determine an I/O power of each I/O port 130 and identify the VMID corresponding to the I/O power. Here, I/O power maybe viewed as the power used to send/receive information associated with each VM. Then for each VMID, the Mpro 150 may accumulate or sum the I/O powers corresponding to each VM, and the accumulated I/O powers may be included in the power buffer 160 corresponding to the VMIDs.

As a further example, regarding the meshes 140, the Mpro 150 may be able to determine a mesh power of each mesh 140 and identify the VMID corresponding to the mesh power. Here, mesh power maybe viewed as the power used by the meshes 140 associated with each VM. Then for each VMID, the Mpro 150 may accumulate or sum the mesh powers corresponding to each VM, and the accumulated mesh powers may be included in the power buffer 160 corresponding to the VMIDs.

However, in one or more aspects, for some of the HW entities, it may not be practical to detect or otherwise directly determine the power used for each VM. In FIG. 2, it is assumed that there is no direct determination of memory powers, I/O powers and/or mesh powers for each VM. Instead, it is assumed that total memory power (representing total power consumed by MCUs 120 and memories 125), total I/O power (representing total power consumed by I/O ports 130), and/or total mesh power (representing total power consumed by meshes 140) during each DPM interval may be determined.

In these instances, portions of the total powers may be assigned to the active VMs, which may be viewed as VMs that are active during the DPM interval. In one aspect, the Mpro 150 may divide the total powers equally among the active VMs. For example, the first and second memory powers may be equal, the first and second I/O powers may be equal, and/or the first and second mesh powers may be equal.

Alternatively, the Mpro 150 may divide the total power proportionately among the active VM using the core powers as the reference. For example, the first and second memory powers may respectively be proportional to the first and second core powers, the first and second I/O powers may respectively be proportional to the first and second core powers, and/or the first and second mesh powers may respectively be proportional to the first and second core powers.

The assigned powers may be included in the VM powers of the VMs. That is, the first VM power may include the first memory power, the first I/O power, and/or the first mesh power in addition to the first core power. Similarly, the second VM power may include the second memory power, the second I/O power, and/or the second mesh power in addition to the second core power.

The core powers, memory powers, I/O powers, and the mesh powers may NOT represent the total power consumed by the compute node 100 during the DPM interval. In this instance, the Mpro 150 may be configured to assign portions of the remaining power (total power-sum of core, memory, I/O, mesh powers) to the active VMs (equally, proportional to core powers, etc.).

The Mpro 150 may be configured to report the VM powers to an operating system (OS) through the FW interface (I/F). This can allow the OS to configure, provide/receive data, and reset the compute node 100, which in turn can enable the OS to accurately allocate the compute node energy for intelligent prioritization of the SW entities for execution on the compute node 100. In this way, the OS may reduce or even eliminate the likelihood of the compute node power to exceed the compute node level power threshold.

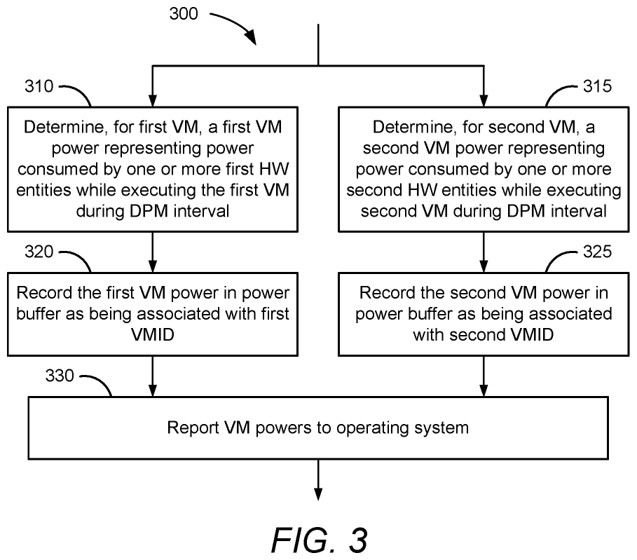

FIG. 3 illustrates a flow chart of an example method 300 of a compute node, such as the compute node 100, for fine-grained power estimation in accordance with one or more aspects of the disclosure. In an aspect, the method 300 may be performed by the Mpro 150. For ease of reference and clarity, it may be assumed that a plurality of hardware (HW) entities (e.g., cores 110, MCUs 120, I/O ports 130, meshes 140) are associated with executions of one or more virtual machines (VM) including first and second VMs. There may be one or more software (SW) entities, and each VM may be an instantiation of one of the SW entities. That is, the first and second VMs may be instantiations of first and second SW entities, respectively, for execution on the compute node 100. One or more of the HW entities may be first HW entities (e.g., 110A, 120A, 130A, 140A) associated with the execution of the first VM during a DPM interval. One or more of the HW entities may be second HW entities (e.g., 110B, 120B, 130B, 140B) associated with the execution of the second VM during the DPM interval.

In block 310, the Mpro 150 may determine, for the first VM, a first VM power representing power consumed by the one or more first HW entities while executing the first VM during the DPM interval.

In block 315, the Mpro 150 may determine, for the second VM, a second VM power representing power consumed by the one or more second HW entities while executing the second VM during the DPM interval.

In block 320, the Mpro 150 may record the first VM power in the power buffer 160. In block 325, the Mpro 150 may record the second VM power in the power buffer 160. As mentioned, the power buffer 160 may be from memories and/or buffers used to hold data in execution of the one or more VMs. The one or more VMs may each be identified with a VM identifier (e.g., VMID, ASID, PARTID, etc.). A first VM identifier may identify the first VM. The first VM power may be recorded in the power buffer 160 as being associated with the first VM identifier. Similarly, a second VM identifier may identify the second VM. The second VM power may be recorded in the power buffer 160 as being associated with the second VM identifier.

In block 330, the Mpro 150 may report the VM powers including the first and second VM powers to an operating system (OS).

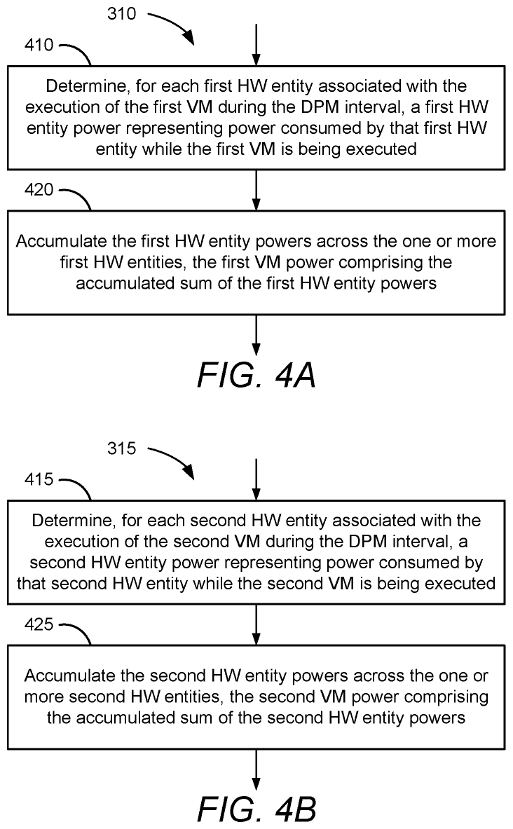

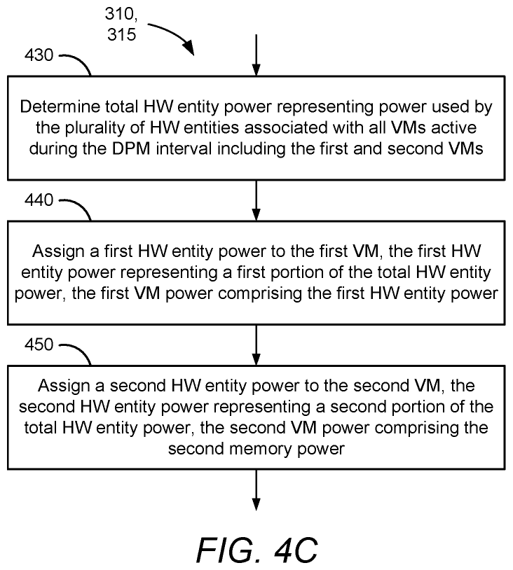

FIG. 4A illustrates a flow chart of an example process to implement block 310. This may be viewed as a process associated with generic first HW entities (e.g., 110A, 120A, 130A, 140A, etc.). In block 410, the Mpro 150 may determine, for each first HW entity associated with the execution of the first VM during the DPM interval, a first HW entity power representing power consumed by that first HW entity while the first VM is being executed.

In block 420, the Mpro 150 may accumulate the first HW entity powers across the one or more first HW entities. The first VM power may comprise the accumulated sum of the first HW entity powers.

FIG. 4B illustrates a flow chart of an example process to implement block 315. This may be viewed as a process associated with generic second HW entities (e.g., 110B, 120B, 130B, 140B, etc.). In block 415, the Mpro 150 may determine, for each second HW entity associated with the execution of the second VM during the DPM interval, a second HW entity power representing power consumed by that second HW entity while the second VM is being executed.

In block 425, the Mpro 150 may accumulate the second HW entity powers across the one or more second HW entities. The second VM power may comprise the accumulated sum of the second HW entity powers.

FIG. 4C illustrates a flow of an example process to implement blocks 310 and 315. The process of FIG. 4C may apply to those HW entities in which total powers are determined (e.g., total power consumed by MCUs 120, memories 125, I/O ports 130, meshes 140, etc.) rather than individual HW powers. In block 430, the Mpro 150 may determine a total HW entity power used by the plurality HW entities associated with all VMs active during the DPM interval including the first and second VMs.

In block 440, the Mpro 150 may assign a first HW entity power to the first VM. The first HW entity power may represent a first portion of the total HW entity power. The first VM power may comprise the first HW entity power.

In block 450, the Mpro 150 may assign a second HW entity power to the second VM. The second HW entity power may represent a second portion of the total HW entity power. The second VM power may comprise the second HW entity power.

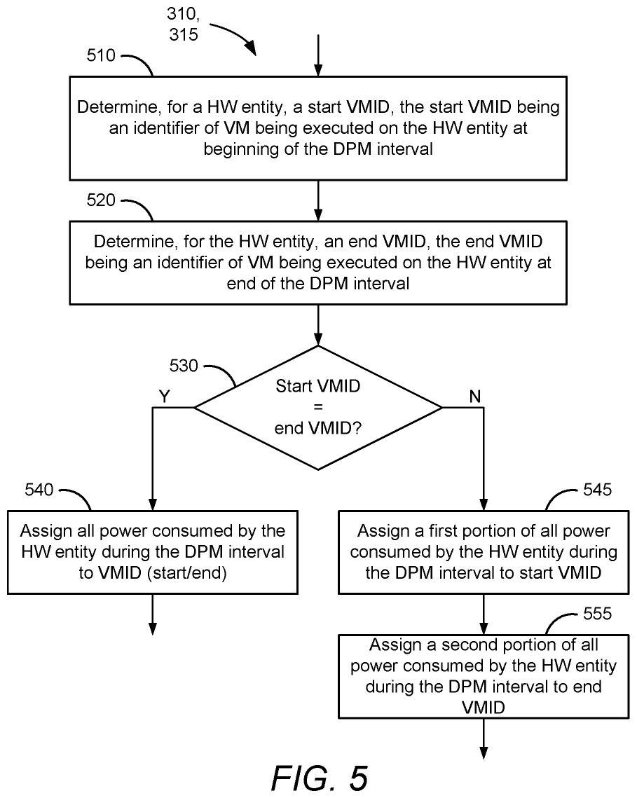

FIG. 5 represents a flow chart of a process to implement block 310 and 315 in an instance where a HW entity (e.g., a core 110) executes more than one VM during a DPM interval. Referring back to FIG. 2, note that the Mpro 150 may sample or otherwise determine the VMID each core executes at the beginning of a DPM interval and at the end of the DPM interval.

With continuing reference to FIG. 5, in block 510, the Mpro 150 may determine for the HW entity (e.g., core 110), a start VMID, which may be an identifier of the VM being executed on the HW entity at the beginning of the DPM interval.

In block 520, the Mpro 150 may determine for the HW entity, an end VMID, which may be an identifier of the VM being executed on the HW entity at the end of the DPM interval.

In block 530, the Mpro 150 may determine whether the start and end VMIDs are the same.

If they are the same (‘Y’ branch from block 530), then in block 540, the Mpro 150 may assign all power consumed by the HW entity during the DPM interval to the same VMID.

On the other hand, if they are not the same (‘N’ branch from block 530), then in block 545, the Mpro 150 may assign a first portion of all power consumed by the HW entity during the DPM interval to the start VMID. In block 555, the Mpro 150 may assign a second portion of all power consumed by the HW entity during the DPM interval to the end VMID. In an aspect, the first and second portions may be equal. Alternatively, the first and second portions may be proportional (e.g., proportional to the corresponding core powers).

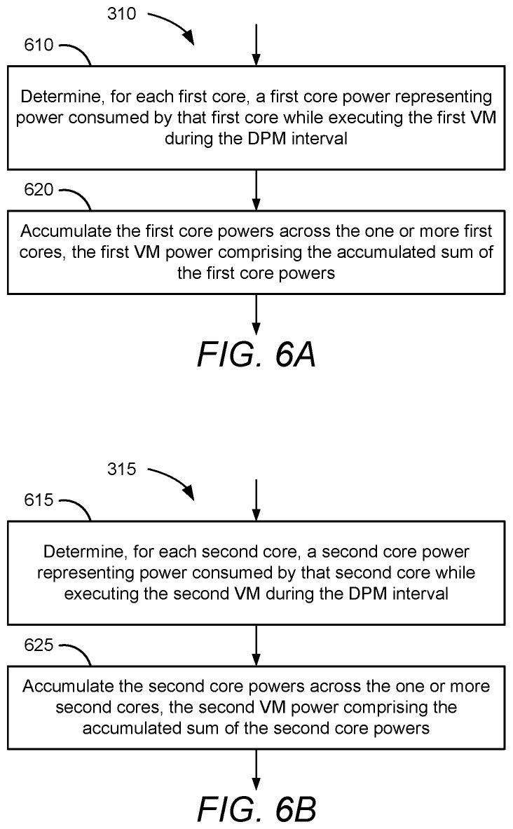

FIG. 6A illustrates a flow chart of an example process to implement block 310. This may be viewed as a process associated with first cores (e.g., cores 110A). In block 610, the Mpro 150 may determine, for each first core 110A, a first core power representing power consumed by that first core 110A while executing the first VM during the DPM interval.

In block 620, the Mpro 150 may accumulate the first core powers across the one or more first cores 110A. The first VM power may comprise the accumulated sum of the first core powers.

FIG. 6B illustrates a flow chart of an example process to implement block 315. This may be viewed as a process associated with second cores (e.g., cores 110B). In block 615, the Mpro 150 may determine, for each second core 110B, a second core power representing power consumed by that second core 110B while executing the second VM during the DPM interval.

In block 625, the Mpro 150 may accumulate the second core powers across the one or more second cores 110B. The second VM power may comprise the accumulated sum of the second core powers.

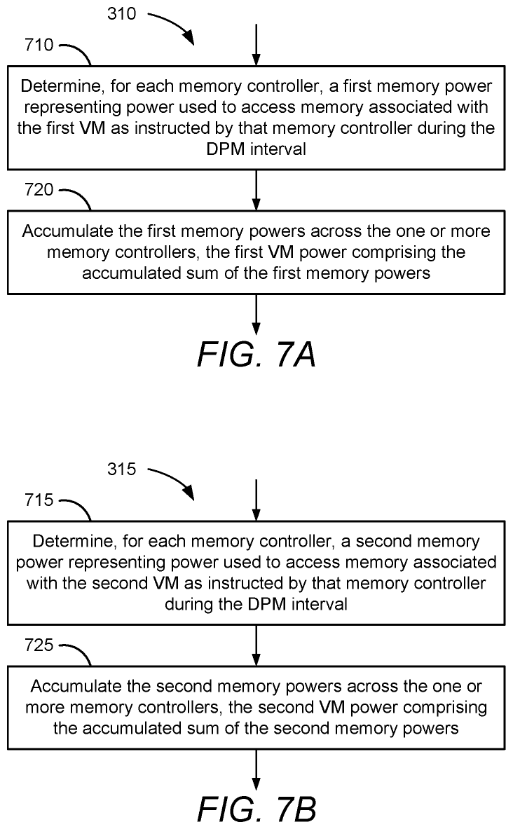

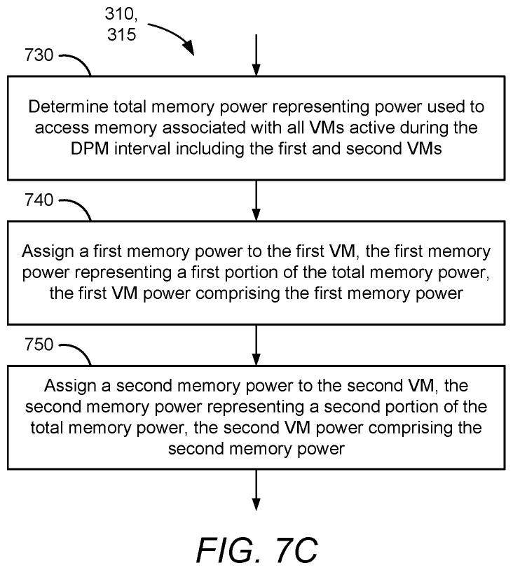

FIG. 7A illustrates a flow chart of another example process to implement block 310. This may be viewed as a process associated with MCUs 120 and memories 125. In block 710, the Mpro 150 may determine, for each memory controller 120, a first memory power representing power used to access memory 125 associated with the first VM as instructed by that memory controller 120 during the DPM interval.

In block 720, the Mpro 150 may accumulate the first memory powers across the one or more memory controllers 120. The first VM power may comprise the accumulated sum of the first memory powers.

FIG. 7B illustrates a flow chart of another example process to implement block 315. This also may be viewed as a process associated with MCUs 120 and memories 125. In block 715, the Mpro 150 may determine, for each memory controller 120, a second memory power representing power used to access memory 125 associated with the second VM as instructed by that memory controller 120 during the DPM interval.

In block 725, the Mpro 150 may accumulate the second memory powers across the one or more memory controllers 120. The second VM power may comprise the accumulated sum of the second memory powers.

FIG. 7C illustrates a flow of another example process to implement blocks 310 and 315. Recall that in an aspect, total memory power may be determined and portions of the total memory power may be assigned as individual memory powers. In block 730, the Mpro 150 may determine a total memory power representing power used to access memory 125 associated with all VMs active during the DPM interval including the first and second VMs.

In block 740, the Mpro 150 may assign a first memory power to the first VM. The first memory power may represent a first portion of the total memory power, and the first VM power may comprise the first memory power.

In block 750, the Mpro 150 may assign a second memory power to the second VM. The second memory power may represent a second portion of the total memory power, and the second VM power may comprise the second memory power.

In an aspect, the assigned first and second memory powers may be equal. Alternatively, the assigned first memory power may be proportional to the first core power, and the assigned second memory power may be proportional to the second core power.

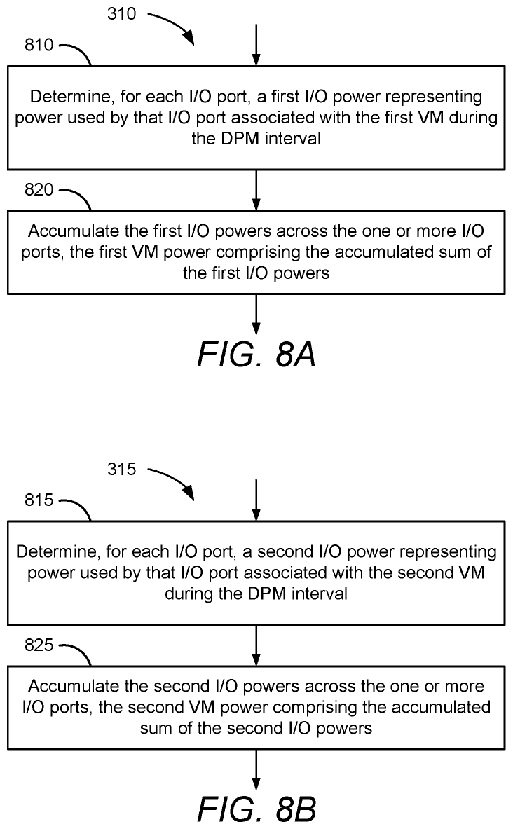

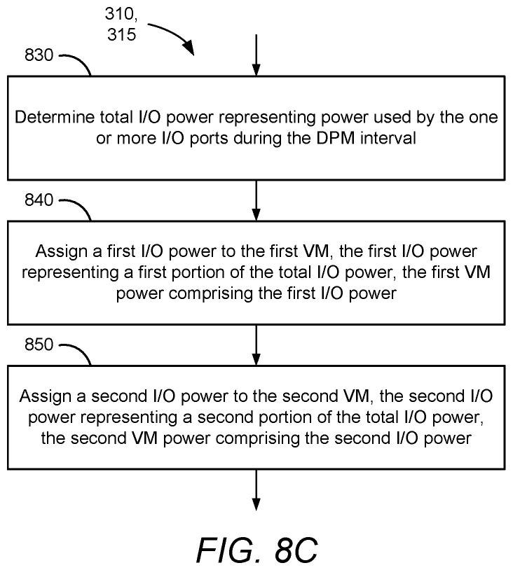

FIG. 8A illustrates a flow chart of another example process to implement block 310. This may be viewed as a process associated with I/O ports 130. In block 810, the Mpro 150 may determine, for each I/O port 130, a first I/O power representing power used by that I/O port 130 associated with the first VM during the DPM interval.

In block 820, the Mpro 150 may accumulate the first I/O powers across the one or more I/O ports 130. The first VM power may comprise the accumulated sum of the first I/O powers.

FIG. 8B illustrates a flow chart of another example process to implement block 315. This also may be viewed as a process associated with I/O ports 130. In block 815, the Mpro 150 may determine, for each I/O port 130, a second I/O power representing power used by that I/O port 130 associated with the second VM during the DPM interval.

In block 825, the Mpro 150 may accumulate the second I/O powers across the one or more I/O ports 130. The second VM power may comprise the accumulated sum of the second I/O powers.

FIG. 8C illustrates a flow of another example process to implement blocks 310 and 315. Recall that in an aspect, total I/O power may be determined and portions of the total I/O power may be assigned as individual I/O powers. In block 830, the Mpro 150 may determine a total I/O power representing power used by the one or more I/O ports 130 during the DPM interval.

In block 840, the Mpro 150 may assign a first I/O power to the first VM. The first I/O power may represent a first portion of the total I/O power, and the first VM power may comprise the first I/O power.

In block 850, the Mpro 150 may assign a second I/O power to the second VM. The second I/O power may represent a second portion of the total I/O power, and the second VM power may comprise the second I/O power.

In an aspect, the assigned first and second I/O powers may be equal. Alternatively, the assigned first I/O power may be proportional to the first core power, and the assigned second I/O power may be proportional to the second core power.

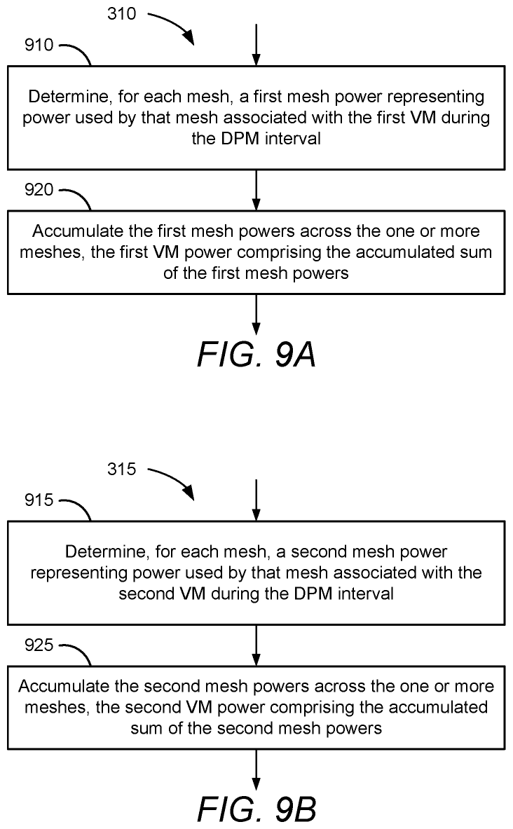

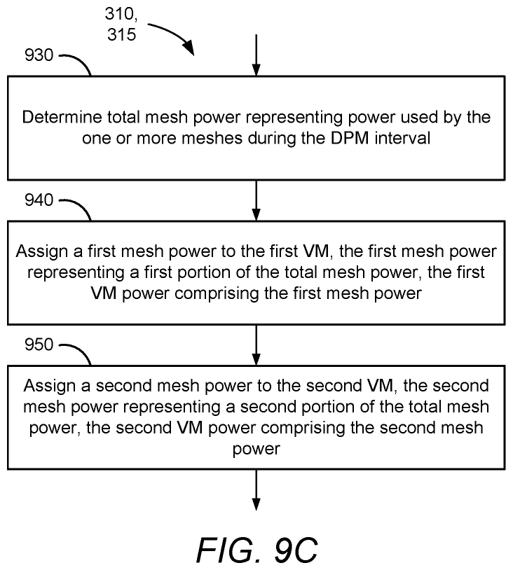

FIG. 9A illustrates a flow chart of another example process to implement block 310. This may be viewed as a process associated with meshes 140. In block 910, the Mpro 150 may determine, for each mesh 140, a first mesh power representing power used by that mesh 140 associated with the first VM during the DPM interval.

In block 920, the Mpro 150 may accumulate the first mesh powers across the one or more meshes 140. The first VM power may comprise the accumulated sum of the first mesh powers.

FIG. 9B illustrates a flow chart of another example process to implement block 315. This also may be viewed as a process associated with meshes 140. In block 915, the Mpro 150 may determine, for each mesh 140, a second mesh power representing power used by that mesh 140 associated with the second VM during the DPM interval.

In block 925, the Mpro 150 may accumulate the second mesh powers across the one or more meshes 140. The second VM power may comprise the accumulated sum of the second mesh powers.

FIG. 9C illustrates a flow of another example process to implement blocks 310 and 315. Recall that in an aspect, total mesh power may be determined and portions of the total mesh power may be assigned as individual mesh powers. In block 930, the Mpro 150 may determine a total mesh power representing power used by the one or more meshes 140 during the DPM interval.

In block 940, the Mpro 150 may assign a first mesh power to the first VM. The first mesh power may represent a first portion of the total mesh power, and the first VM power may comprise the first mesh power.

In block 950, the Mpro 150 may assign a second mesh power to the second VM. The second mesh power may represent a second portion of the total mesh power, and the second VM power may comprise the second mesh power.

In an aspect, the assigned first and second mesh powers may be equal. Alternatively, the assigned first mesh power may be proportional to the first core power, and the assigned second mesh power may be proportional to the second core power.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element unless the connection is expressly disclosed as being directly connected.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Aspects of the present disclosure are illustrated in the description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or one or more claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A compute node, comprising:
a plurality of hardware (HW) entities associated with executions of one or more virtual machines (VM), each VM being an instantiation of a software (SW) entity of one or more SW entities, one or more first HW entities of the plurality of HW entities being associated with an execution of a first VM of the one or more VMs during a digital power meter (DPM) interval, the first VM being an instantiation of a first SW entity for execution on the compute node; and
a microcontroller (Mpro) configured to:
determine, for the first VM, a first VM power representing power consumed by the one or more first HW entities while executing the first VM during the DPM interval.

2. The compute node of claim 1, wherein the DPM interval is 500 μs or less.

3. The compute node of claim 1, wherein in determining the first VM power, the Mpro is configured to:
determine, for each first HW entity associated with the execution of the first VM during the DPM interval, a first HW entity power representing power consumed by that first HW entity while the first VM is being executed, and
accumulate the first HW entity powers across the one or more HW entities, the first VM power comprising the accumulated sum of the first HW entity powers.

4. The compute node of claim 3, further comprising:
a power buffer,
wherein the one or more VMs are each identified with a VM identifier (VMID), a first VMID identifying the first VM, and
wherein the Mpro is further configured to record the first VM power in the power buffer as being associated with the first VMID.

5. The compute node of claim 4, wherein the power buffer is separate from memories and/or buffers used to hold data in execution of the one or more VMs.

6. The compute node of claim 3, wherein the Mpro is configured to determine multiple first VM powers corresponding to multiple DPM intervals when the first VM is executed over the multiple DPM intervals.

7. The compute node of claim 1,
wherein one or more second HW entities of the plurality of HW entities are associated with an execution of a second VM of the one or more VMs during the DPM interval, the second VM being an instantiation of a second SW entity for execution on the compute node, the first and second SW entities being different from each other, and
wherein the Mpro is configured to determine, for the second VM, a second VM power representing power consumed by the one or more second HW entities while the second VM is being executed during the DPM interval.

8. The compute node of claim 7,
wherein at least one core is configured to execute at least a portion of the first VM and at least a portion of the second VM during the DPM interval, and
wherein the Mpro is configured to determine first and second core powers,
the first core power representing power consumed by the at least one core in executing the first VM during the DPM interval, the first core power being included in the first VM power, and
the second core power representing power consumed by the at least one core in executing the second VM during the DPM interval, the second core power being included in the second VM power.

9. The compute node of claim 7, wherein at least one first HW entity is different from at least one second HW entity.

10. The compute node of claim 7,
wherein the plurality of HW entities includes a plurality of cores configured to execute the one or more VMs, one or more first cores of the plurality of cores executing the first VM during the DPM interval, and
wherein in determining the first VM power, the Mpro is configured to:
determine, for each first core, a first core power representing power consumed by that first core while executing the first VM during the DPM interval, and
accumulate the first core powers across the one or more first cores, the first VM power comprising the accumulated sum of the first core powers.

11. The compute node of claim 10, wherein cycles of the plurality of cores are not used in determining the first VM power.

12. The compute node of claim 10,
wherein a second VM of the one or more VMs is executed on one or more second cores of the plurality of cores during the DPM interval, the second VM being an instantiation of a second SW entity for execution on the compute node, the first and second SW entities being different from each other, and
wherein the Mpro is configured to:
determine, for each second core, a second core power representing power consumed by that second core while executing the second VM during the DPM interval, and
accumulate the second core powers across the one or more second cores, a second VM power comprising the accumulated sum of the second core powers, the second VM power representing power consumed by the compute node while the second VM is being executed during the DPM interval.

13. The compute node of claim 12, wherein the Mpro is configured to record in a power buffer, for each DPM interval of multiple DPM intervals, the first and second VM powers corresponding to that DPM interval.

14. The compute node of claim 10,
wherein the plurality of HW entities includes one or more memory controllers, and
wherein the Mpro is configured to:
determine, for each memory controller, a first memory power representing power used to access memory associated with the first VM as instructed by that memory controller during the DPM interval, and
accumulate the first memory powers across the one or more memory controllers, the first VM power comprising the accumulated sum of the first memory powers.

15. The compute node of claim 10,
wherein the plurality of HW entities includes one or more memory controllers, and
wherein the Mpro is configured to:
determine total memory power representing power used to access memory associated with all VMs active during the DPM interval including the first and second VMs,
assign a first memory power to the first VM, the first memory power representing a first portion of the total memory power, the first VM power comprising the first memory power, and
assign a second memory power to the second VM, the second memory power representing a second portion of the total memory power, the second VM power comprising the second memory power.

16. The compute node of claim 15,
wherein the first memory power is equal to the second memory power, or
wherein the first memory power is proportional to first core power and the second memory power is proportional to the second core power.

17. The compute node of claim 10,
wherein the plurality of HW entities includes one or more input/output (I/O) ports, and
wherein the Mpro is configured to:
determine, for each I/O port, a first I/O power representing power used by that I/O port associated with the first VM during the DPM interval, and
accumulate the first I/O powers across the one or more I/O ports, the first VM power comprising the accumulated sum of the first I/O powers.

18. The compute node of claim 10,
wherein the plurality of HW entities includes one or more input/output (I/O) ports, and
wherein the Mpro is configured to:
determine a total I/O power representing power used by the one or more IO ports during the DPM interval,
assign a first I/O power to the first VM, the first I/O power representing a first portion of the total I/O power, the first VM power comprising the first I/O power, and
assign a second I/O power to the second VM, the second I/O power representing a second portion of the I/O power, the second VM power comprising the second I/O power.

19. The compute node of claim 18,
wherein the first I/O power is equal to the second I/O power, or
wherein the first I/O power is proportional to first core power and the second I/O power is proportional to the second core power.

20. The compute node of claim 10,
wherein the plurality of HW entities includes one or more meshes, and
wherein the Mpro is configured to:
determine, for each mesh, a first mesh power representing power used by that mesh associated with the first VM during the DPM interval, and
accumulate the first mesh powers across the one or more meshes, the first VM power comprising the accumulated sum of the one or more first mesh powers.

21. The compute node of claim 10,
wherein the plurality of HW entities includes one or more meshes, and
wherein the Mpro is configured to:
determine total mesh power representing power used by the one or more meshes during the DPM interval,
assign a first mesh power to the first VM, the first mesh power representing a first portion of the total mesh power, the first VM power comprising the first mesh power, and
assign a second mesh power to the second VM, the second mesh power representing a second portion of the total mesh power, the second VM power comprising the second mesh power.

22. The compute node of claim 21,
wherein the first mesh power is equal to the second mesh power, or
wherein the first mesh power is proportional to first core power and the second mesh power is proportional to the second core power.

23. The compute node of claim 7, wherein the Mpro is configured to report the first and second VM powers to an operating system (OS).

24. The compute node of claim 1, wherein the compute node is a system-on-chip (SoC) device.

25. A method of attributing power to a compute node, the compute node comprising a plurality of hardware (HW) entities and a microcontroller (Mpro), the plurality of HW entities being associated with executions of one or more virtual machines (VM), each VM being an instantiation of a software (SW) entity of one or more SW entities, one or more first HW entities of the plurality of HW entities being associated with an execution of a first VM of the one or more VMs during a digital power meter (DPM) interval, the first VM being an instantiation of a first SW entity for execution on the compute node, the method comprising:
determining by the Mpro, for a first VM, for the first VM, a first VM power representing power consumed by the one or more first HW entities while executing the first VM during the DPM interval.

26. The method of claim 25, wherein determining the first VM power comprises:
determining, for each first HW entity associated with the execution of the first VM during the DPM interval, a first HW entity power representing power consumed by that first HW entity while the first VM is being executed; and
accumulating the first HW entity powers across the one or more first HW entities, the first VM power comprising the accumulated sum of the first HW entity powers.

27. The method of claim 25,
wherein one or more second HW entities of the plurality of HW entities are associated with an execution of a second VM of the one or more VMs during the DPM interval, the second VM being an instantiation of a second SW entity for execution on the compute node, the first and second SW entities being different from each other, and
wherein the method further comprises:
determining by the Mpro, for the second VM, a second VM power representing power consumed by the one or more second HW entities while the second VM is being executed during the DPM interval.

28. The method of claim 27,
wherein the plurality of HW entities includes a plurality of cores configured to execute the one or more VMs, one or more first cores of the plurality of cores executing the first VM during the DPM interval, and
wherein determining the first VM power comprises:
determining, for each first core, a first core power representing power consumed by that first core while executing the first VM during the DPM interval, and
accumulating the first core powers across the one or more first cores, the first VM power comprising the accumulated sum of the first core powers.

29. The method of claim 28, wherein cycles of the plurality of cores are not used in determining the first VM power.

30. The method of claim 25, further comprising:
recording the first VM power in a power buffer,
wherein the power buffer is separate from memories and/or buffers used to hold data in execution of the one or more VMs,
wherein the one or more VMs are each identified with a VM identifier (VMID), a first VMID identifying the first VM, and
wherein the first VM power is recorded in the power buffer as being associated with the first VMID.
